(19) United States
(12) Patent Application Publication
(10) Pub. No.: US 2025/0142159 A1
(43) Pub. Date: May 1, 2025

(54) INTERFACE DISPLAY METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Ting YANG, Beijing (CN); Jiaxin WANG, Beijing (CN)

(21) Appl. No.: 18/726,061

(22) PCT Filed: Dec. 20, 2022
(86) PCT No.: PCT/CN2022/140428

§ 371 Date: Jul. 1, 2024

(30) Foreign Application Priority Data
Dec. 30, 2021 (CN) 202111652364.4

(51) Int. Cl. H04N 21/431; G06F 3/04847; H04N 21/4722

(52) U.S. Cl. CPC H04N 21/4316; G06F 3/04847; H04N 21/4722

(57) ABSTRACT

A interface display method. The method comprises: receiving a trigger operation which acts on a preset control, wherein the preset control is displayed in a playing interface of a target video, and the playing interface is used for playing a target picture at an initial position; in response to the trigger operation, acquiring a target area associated with the preset control; and displaying a fusion interface of the target area and the target picture of the target video, wherein the target picture is kept in a playing state.

### CROSS-REFERENCE TO RELATED APPLICATIONS

The present application is a national phase application of PCT/CN2022/140428 filed Dec. 20, 2022, which claims priority to and is based on a Chinese application with an application Ser. No. 20/211,1652364.4 and a filing date of Dec. 30, 2021, the aforementioned applications are hereby incorporated by reference in their entireties.

### FIELD OF THE INVENTION

The present disclosure relates to the field of information technology, and in particular to a interface display method, apparatus, electronic device and storage medium.

### BACKGROUND

With continuous development of network technology and terminal technology, more and more clients appear, and users can carry out different online activities through different types of clients. For example, users can watch videos through video clients.

### DISCLOSURE OF THE INVENTION

The embodiments of the present disclosure provide a interface display method, apparatus, electronic device and storage medium.

An embodiment of the present disclosure provides a interface display method, including:
receiving a trigger operation acting on a preset control, wherein the preset control is displayed in a playing interface of a target video, and the playing interface is used for playing a target picture at an initial position;
in response to the trigger operation, acquiring a target area associated with the preset control; and
displaying a fusion interface of the target area and the target picture of the target video, wherein the target area appears from a preset position in the display interface and moves in a preset direction, and the target picture of the target video moves on the display interface from the initial position in the preset direction, and the target picture is kept in a playing state.

An embodiment of the present disclosure also provides a interface display apparatus, which includes:
a receiving module, configured to receive a trigger operation acting on a preset control, wherein the preset control is displayed in a playing interface of a target video, and the playing interface is used for playing a target picture at an initial position;
an acquisition module, configured to, in response to the trigger operation, acquire a target area associated with the preset control; and
a displaying module, configured to display a fusion interface of the target area and the target picture of the target video, wherein the target area appears from a preset position in the display interface and moves in a preset direction, and the target picture of the target video moves on the display interface from the initial position in the preset direction, while the target picture is kept in a playing state.

An embodiment of the present disclosure also provides an electronic device, and the electronic device includes:
one or more processors;
a storage device for storing one or more programs;

Wherein the one or more programs, when executed by the one or more processors, cause the one or more processors to implement the above interface display method.

An embodiment of the present disclosure also provides a computer-readable storage medium, on which a computer program is stored, wherein the program, when executed by a processor, cause implementation of the above interface display method.

### DESCRIPTION OF THE DRAWINGS

The above and other features, advantages and aspects of embodiments of the present disclosure will become more obvious in combination with accompanying drawings and with reference to embodiments of the present disclosure. Throughout the drawings, the same or similar reference numbers indicate the same or similar elements. It shall be understood that the drawings are illustrative, and the originals and elements are not drawn to scale.

FIG. 1 is a flowchart of a interface display method in an embodiment of the present disclosure;

FIG. 2 is a schematic diagram of a play interface of a target video in an embodiment of the present disclosure;

FIG. 3 is a schematic diagram of a fusion interface in an embodiment of the present disclosure;

FIG. 4 is a schematic diagram of another fusion interface in the embodiment of the present disclosure;

FIG. 5 is a schematic diagram of a fusion interface in an embodiment of the present disclosure;

FIG. 6 is a schematic diagram of a display interface in an embodiment of the present disclosure;

FIG. 7 is a schematic diagram of a fusion interface in an embodiment of the present disclosure;

FIG. 8 is a schematic structural diagram of a interface display apparatus in an embodiment of the present disclosure;

FIG. 9 is a schematic structural diagram of an electronic device in an embodiment of the present disclosure.

### DETAILED DESCRIPTION OF PREFERRED EMBODIMENTS

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of other terms will be given in the following description.

It should be noted that the concepts of “first”, “second”, etc. mentioned in the present disclosure are only used to distinguish different apparatuses, modules or units, instead of limiting the order or interdependence of functionalities performed by these apparatuses, modules or units.

It should be noted that the modifications of “a” and “a plurality” mentioned in the present disclosure are schematic rather than limiting, and those skilled in the art should understand that unless otherwise clearly indicated in the context, they should be understood as “one or more”.

Names of messages or information exchanged among multiple apparatuses in embodiments of the present disclosure are only used for illustrative purposes, instead of limiting the scopes of these messages or information.

Other information is usually displayed in a video playing interface, for example, the video playing interface about food usually displays information about a restaurant where you can taste the foods. By clicking on the restaurant information, a personal can enter the restaurant-related interface, however, the effect of viewing the video during interface switching is not good.

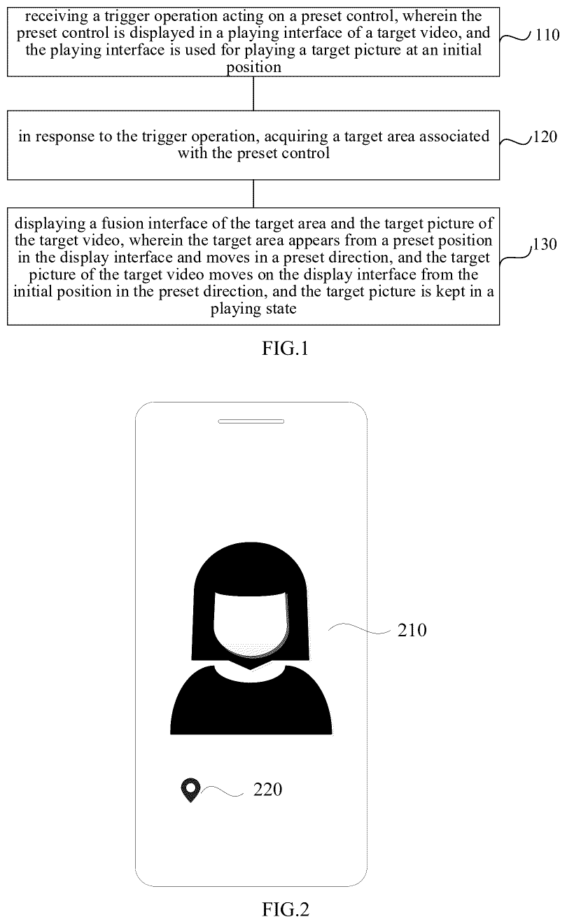

FIG. 1 is a flow chart of a interface display method in an embodiment of the present disclosure, the method can be executed by a interface display apparatus, which may be implemented in the form of software and/or hardware, and which may be configured in an electronic device, such as a terminal, specifically including but not limited to smartphone, palmtop computer, tablet computer, wearable device with screen, desktop computer, laptop computer, all-in-one machine, smart home equipment, etc.

As shown in FIG. 1, the method specifically may include the following steps:

Step 110: receiving a trigger operation acting on a preset control, wherein the preset control is displayed in a playing interface of a target video, and the playing interface is used for playing a target picture at an initial position.

Wherein, the preset control may specifically be an entry for details information about a preset object displayed on the target picture. Exemplarily, with reference to a schematic diagram of a play interface of a target video as shown in FIG. 2, a preset control 220 is displayed on the target picture 210 of the target video, and exemplarily, the preset control 220 specifically may be an entry for details information about a restaurant.

Step 120, in response to the trigger operation, acquiring a target area associated with the preset control.

Wherein, the target area associated with the preset control may specifically be a interface displaying target information associated with the preset control. Taking FIG. 2 as an example, when the preset control 220 is an entry locating the details information about restaurant B, the target area is a interface where target information related to restaurant B, such as geographical location of restaurant B, dishes on sale, etc., is displayed.

Specifically, the association relationship between the preset control and the target area can be established in advance, and when it is detected that the preset control is triggered, the target area associated with the preset control can be acquired.

Step 130, displaying a fusion interface of the target area and the target picture of the target video, wherein the target area appears from a preset position in the display interface and moves in a preset direction, and the target picture of the target video moves on the display interface from the initial position in the preset direction, while the target picture is kept in a playing state.

The target picture of the target video from a previous playing interface and the target area are concurrently displayed in the fusion interface, so as to provide a transitional stage for switching from the target picture to the target area, reduce the sense of jumping during switching, and improve visual effect of the user viewing the target picture of the target video.

A preset position for the display interface may be the left side, the right side, the bottom or the top of the display interface. Taking the preset position being the bottom of the display interface as an example, the target area appears from the bottom of the display interface, and the way of appearance can be superimposed with certain special effects, such as directly popping up or cutting out from the bottom of the display interface to appear special effects. After having appeared from the preset position of the display interface, the target area moves a certain distance on the display interface in the preset direction, to completely display some information on the target area; concurrently, the target picture also moves a certain distance on the display interface in the same direction, to ensure that the target area and the target picture are concurrently displayed on the display interface, while the target picture is kept in the playing state. It should be noted that when the target picture moves on the display interface in the preset direction, the size of the target picture remains unchanged, that is, the target picture is not zoomed, while the center of the target picture is kept in displaying.

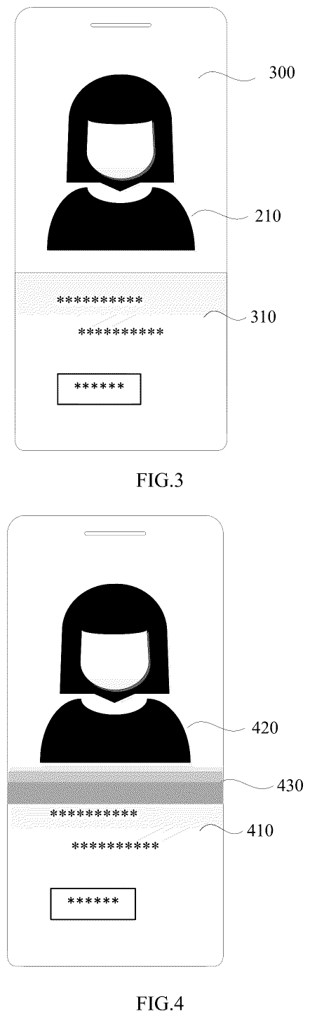

Exemplarily, referring to the schematic diagram of a fusion interface as shown in FIG. 3, compared with that shown in FIG. 2, it can be seen that the fusion interface also includes a playing area concurrently when the target area appears, and the playing area is used to play the target picture 210. The target picture 210 moves a certain distance from the initial position in the same moving direction as the target area on the display interface 300, and the target area 310 is displayed on the display interface 300 concurrently, wherein, in a full-screen display mode, the display interface 300 is a display area of the display screen. In other words, in the fusion interface, the user can see both the target picture 210 and the target area 310, which is a transition stage for switching from the target picture 210 to the target area 310. By adding the transition stage, the playing of the target picture will not be directly interrupted, and the sense of jumping for switching from the target picture 210 to the target area 310 can be reduced, thereby improving viewing effect.

Further, in order to reduce the sense of jumping during picture switching and improve the visual effect, refer to the schematic diagram of another fusion interface as shown in FIG. 4, wherein, in the fusion interface, the target area 410 and the target picture 420 of the target video are connected through the gradient layer 430, so as to improve the visual effect presented by the fusion interface to the user, reduce the sense of jumping during picture switching, and improve the visual effect.

In some implementations, in response to an operation of sliding a preset area in the fusion interface along a first direction, the target area is controlled to move on the display interface along the first direction, so that a first area where the target area is displayed increases, and concurrently, the target picture of the target video is controlled to move on the display interface along the first direction, so that a second area where the target picture is displayed decreases. Wherein, the preset area may be the target area, or an area where the target picture is located. The first direction may be from bottom to top, from top to bottom, from left to right, or from right to left, and so on. Taking the target area appearing from the bottom of the display interface and the first direction being from bottom to top, specifically, when the user slides the preset area from bottom to top, the target area moves on the display interface from bottom to top, concurrently, the target picture also moves on the display interface from bottom to top. It can be understood that during the moving process, in the display interface, the second area occupied by the target picture becomes smaller and smaller, and the first area occupied by the target area becomes larger and larger, until the display interface is completely occupied by the target area, and the target picture disappears from the display interface, so far the switching from the target picture to the target area is completed. By switching gradually, the sense of jumping when switching screens can be reduced and the visual effect can be improved. It should be noted that, during the moving process, the size of the target picture does not change, that is, the target picture does not zoom, but the center of the target picture is kept in displaying, while the second area of the display interface occupied by the target picture becomes smaller and smaller. Exemplarily, referring to a schematic diagram of a fusion interface as shown in FIG. 5, the fusion interface shown in FIG. 5 may correspond to a display effect obtained by sliding the target area 410 or the target picture 420 upwards on the basis of the fusion interface as shown in FIG. 4, it can be seen that the target picture 420 is displayed higher, the area, that is, the first area, of the display interface occupied by the target area 410 gets larger and larger, and the area, that is, the second area, of the display interface occupied by the target picture 420 gets smaller or smaller.

Similarly, when the user slides the preset area from top to bottom, the target area moves on the display interface from top to bottom, and concurrently, the target picture also moves on the display interface from top to bottom. It can be understood that during the moving process, in the display interface, the second area occupied by the target picture becomes larger and larger, and the first area occupied by the target area becomes smaller and smaller, until the display interface is completely occupied by the target area, and the target picture disappears from the display interface.

In general, in response to an operation of sliding a preset area in the fusion interface along a second direction, the target area is controlled to move on the display interface along the second direction, so that a first area where the target area is displayed decreases, and concurrently, the target picture of the target video is controlled to move on the display interface along the second direction, so that a second area where the target picture is displayed increases.

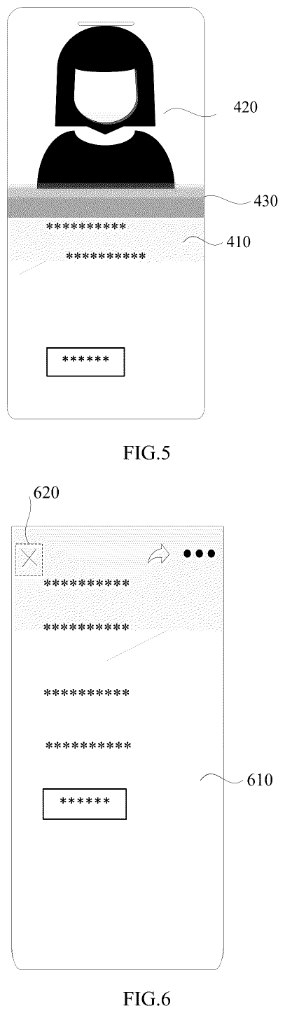

Further, when the target picture moves to a second set position on the display interface, the target picture of the target video is hidden, and the target area is displayed in full screen. Specifically, when the center point of the target picture reaches the second set position on the display interface, the target picture is hidden, and the target area is displayed in full screen, realizing the complete process of switching from the target picture to the target area. Exemplarily, referring to a schematic diagram of a display interface as shown in FIG. 6, the target area 610 is displayed in full screen in the display interface, and the target picture is no longer displayed.

After the target area is displayed in full screen, the method further includes: in response to an operation of sliding the target area along the second direction, controlling the target area to move on the display interface along the second direction, and concurrently controlling the playing interface for the target video to be restored and displayed on the display interface. Specifically, it is assumed that the target area appears from the bottom of the display interface, and moves on the display interface from bottom to top, and concurrently, the target picture also moves on the display interface from bottom to top, the target area and the target picture stop moving after have moved a certain distance, at this time, the fusion interface of the target area and the target picture is displayed on the display interface. When the user slides the preset area in the fusion interface from bottom to top, the target area and the target picture continue to move upward on the display interface, and when the target picture moves to the second set position on the display interface, the target picture is hidden, and the display interface is fully occupied by the target area. At this time, if the user slides the target area from top to bottom, the target picture of the target video would appear from the top of the display interface, and its display on the display interface restores, and concurrently, the target area slides on the display interface from top to bottom.

It can be understood that when the target picture is displayed, by taking the center point of the target picture as a reference, the target picture can be displayed in a certain area on the display interface that matches the size of the target picture. Therefore, the moving speed of the target picture is smaller than the moving speed of the target area. Specifically, the speed at which the target picture moves on the display interface along the first direction is smaller than the speed at which the target area moves on the display interface along the first direction. A speed at which the target picture moves on the display interface along the second direction is smaller than a speed at which the target area moves on the display interface along the second direction.

Alternatively, in some implementations, when the target picture moves to the first set position on the display interface, the target picture can be switched to a preset picture associated with the target area. The preset picture can be a picture or a video. That is, what is displayed in the fusion interface is no longer the target area and the target picture of the target video, but the target area and a preset picture associated with the target area. For example, the target area is the details interface information about a restaurant, and the preset picture associated with the target area can be a picture of the restaurant, or a screen of a video of making or explaining a certain special dish in the restaurant, so as to improve the user's viewing effect when viewing the target area.

Alternatively, in some embodiments, the method also includes:
in response to a trigger operation acting on the first control in the fusion interface, control the target area to be closed, and display the target picture of the target video in full screen.

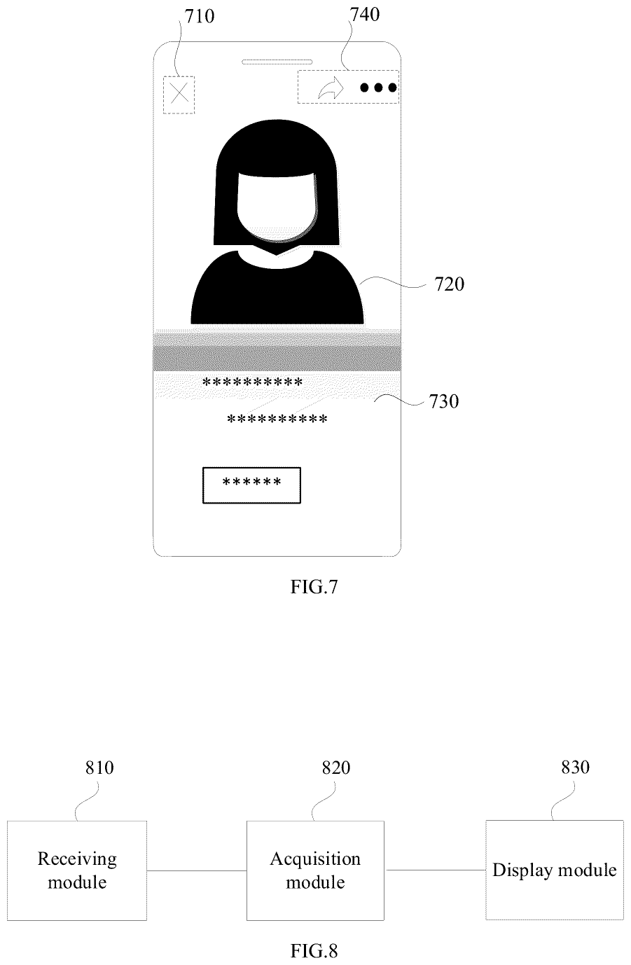

Exemplarily, referring to a schematic diagram of a fusion interface as shown in FIG. 7, when the target area and the target picture of the target video are displayed on the display interface concurrently, the first control 710 is displayed in the target picture 720 of the target video, and at least one preset control 740 associated with the target area 730 is also displayed in the target picture 720. The at least one preset control includes a sharing control, through which an information interface generated from the target area can be shared with other users.

Exemplarily, the method further includes: in response to a trigger operation acting on the sharing control, generating an information interface based on the target area, so as to share the information interface; wherein, when the target area and the target picture are concurrently displayed on the display interface, the sharing control is displayed in the target picture.

When the target area is displayed on the display interface, whose essence is that a interface associated with the target area is displayed on the display interface, in order to reduce the sense of jumping when switching from the playing interface of the target video, the target area and the playing interface of the target video are displayed on the display interface concurrently, the target area and the target picture of the target video are connected through a gradient layer to improve visual effect, etc.

It can be understood that, when the target area is displayed in full screen, the first control associated with the target area is displayed in the target area, such as the first control 620 shown in FIG. 6, when the user triggers the first control 620, the target area can be closed and then switch back to the playing interface of the target video.

Further, the target picture of the target video can be a picture in which the center area of the target picture (the central area may be located at ½ of the vertical height of the target video) matches the second area where the target picture is displayed in terms of size, for example, the ½ point of the vertical height of the target video coincides with the central point of the second area; or, the target picture of the target video is a picture for an target object in the target video that matches the size of the second area.

In the interface display method provided by embodiments of the present disclosure, during switching from the target picture of the target video to the target area associated with the preset control, the target picture moves on the display interface in the preset direction, and concurrently, the target area also moves in the preset direction so that the target area displayed on the display interface becomes larger and larger, therefore, the target area can be gradually fused with the target picture to obtain a fusion interface, thereby improving viewing effect.

In summary, the playing interface of the target video can be regarded as the homeinterface, taking full-screen display of the homeinterface as an example, when the user triggers the preset control displayed on the homeinterface, the target area associated with the preset control can appear from the preset position on the display interface, for example, when it appears from the bottom of the display interface, the homeinterface moves upwards, and the center area of the target video (usually at ½ of the vertical height of the target video) is always displayed in a visible area (that is, the display interface), and the target area moves upwards and appears, the target area and the home interface form a fusion interface, the target area and the target picture of the target video are connected through a gradient layer, and the top operation area of the target area (including close control, sharing control and more controls) can gradually displace and appear from the top of the display interface, so the top operation area of the target area is initially displayed on the home interface and only when the target area is displayed in full screen, the top operation area of the target area is displayed in the target area. Before the target area is displayed in full screen, the user can slide up the target area or the home interface to make the target area gradually occupy the entire display interface, and finally move the home interface out of the display interface to realize the full screen display of the target area. After the target area is displayed in full screen, the user can slide down the target area to make the home interface appear on the display interface again from the top of the display interface. By adding the transition stage between the home interface and the target area, the sense of jumping during switching from the home interface to the target area can be reduced.

FIG. 8 is a schematic structural diagram of a interface display apparatus in an embodiment of the present disclosure. The interface display apparatus specifically includes: a receiving module 810, an acquisition module 820 and a display module 830.

Wherein, a receiving module 810 is configured to receive a trigger operation acting on a preset control, wherein the preset control is displayed in a playing interface of a target video, and the playing interface is used for playing a target picture at an initial position; an acquisition module 820 is configured to, in response to the trigger operation, acquire a target area associated with the preset control; and a displaying module 830 is configured to display a fusion interface of the target area and the target picture of the target video, wherein the target area appears from a preset position in the display interface and moves in a preset direction, and the target picture of the target video moves on the display interface from the initial position in the preset direction, while the target picture is kept in a playing state.

Alternatively, in the fusion interface, the target area and the target picture of the target video are connected through a gradient layer.

Alternatively, it also includes: a control module, configured to, in response to an operation of sliding a preset area in the fusion interface along a first direction, control the target area to move on the display interface along the first direction, so that a first area where the target area is displayed increases, and concurrently control the target picture of the target video to move on the display interface along the first direction, so that a second area where the target picture is displayed decreases.

Alternatively, the speed at which the target picture moves on the display interface along the first direction is smaller than the speed at which the target area moves on the display interface along the first direction.

Alternatively, the control module is further configured to: in response to an operation of sliding a preset area in the fusion interface along a second direction, control the target area to move on the display interface along the second direction, so that a first area where the target area is displayed decreases, and concurrently control the target picture of the target video to move on the display interface along the second direction, so that a second area where the target picture is displayed increases.

Alternatively, it further includes a switching module, configured to, when the target picture moves to the first set position on the display interface, switch the target picture to a preset picture associated with the target area.

Alternatively, it further includes a hiding module, configured to, when the target picture moves to a second set position on the display interface, hide the target picture of the target video, and the target area is displayed in full screen.

Alternatively, it further includes a restoration module, configured to, after the target area is displayed in full screen, in response to an operation of sliding the target area along the second direction, control the target area to move on the display interface along the second direction, and concurrently control the playing interface for the target video to be restored and displayed on the display interface.

Alternatively, the control module is further configured to: in response to a trigger operation acting on the first control in the fusion interface, control to close the target area and display the target picture of the target video in full screen.

Alternatively, when the target area and the target picture of the target video are concurrently displayed on the display interface, the first control is displayed in the target picture of the target video, and the target picture is also displayed with at least one preset control associated with the target area.

Alternatively, the target picture of the target video is a picture in which the size of the center area of the target picture matches the size of the second area displaying the target picture; or, the target picture of the target video is a picture for a target object in the target video that matches the second area in terms of size.

Alternatively, the apparatus further includes: a sharing module, configured to, in response to a trigger operation acting on the sharing control, generate an information interface based on the target area for sharing; wherein, when the target area and the target picture are concurrently displayed on the display interface, the sharing control is displayed in the target picture.

The interface display apparatus provided by the embodiment of the present disclosure can execute the steps in the interface display method provided by the method embodiments of the present disclosure, and has execution steps and beneficial effects, which will not be repeated here.

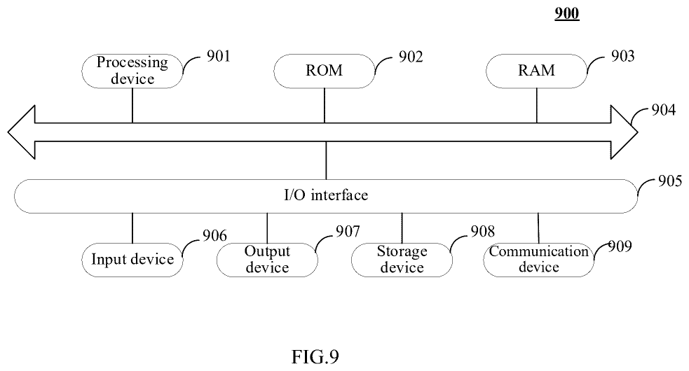

FIG. 9 is a schematic structural diagram of an electronic device provided by an embodiment of the present disclosure. Referring specifically to FIG. 9, there is shown a structural schematic diagram of an electronic device 900 suitable for implementing an embodiment of the present disclosure. The electronic device 900 in the embodiment of the present disclosure may include, but not limited to, a mobile terminal such as a mobile phone, a notebook computer, a digital broadcast receiver, a PDA (Personal Digital Assistant), a PAD (Tablet Computer), a PMP (Portable Multimedia Player), a vehicle-mounted terminal such as a vehicle navigation terminal, and a fixed terminal such as a digital TV and a desktop computer. The electronic device shown in FIG. 9 is only an example, and should not bring any limitation to functions and application scopes of the embodiments of the present disclosure.

As shown in FIG. 9, an electronic device 900 may include a processing device (such as a central processing unit, a graphics processor, etc.) 901, which may perform various appropriate actions and processes according to a program stored in a read-only memory (ROM) 902 or a program loaded from a storage device 908 into a random-access memory (RAM) 903. In the RAM 903, various programs and data required for the operation of the electronic device 900 are also stored. A processing device 901, a ROM 902 and a RAM 903 are connected to each other through a bus 904. An input/output (I/O) interface 905 is also connected to the bus 904.

Generally, the following devices can be connected to the I/O interface 905: an input device 906 including, for example, touch screen, touch pad, keyboard, mouse, camera, microphone, accelerometer, gyroscope, etc.; an output device 907 such as Liquid Crystal Display (LCD), speakers, vibrators, etc.; a storage device 908 including a magnetic tape, a hard disk, etc.; and a communication device 909. The communication device 909 may allow the electronic device 900 to communicate with other devices wirelessly or in wired so as to exchange data. Although FIG. 9 shows an electronic device 900 with various devices, it should be understood that it is not required to implement or have all the devices shown. More or fewer devices may alternatively be implemented or provided.

Particularly, according to embodiments of the present disclosure, the process described above with reference to the flowchart can be implemented as a computer software program. For example, an embodiment of the present disclosure includes a computer program product including a computer program carried on a non-transitory computer readable medium, the computer program containing program codes for executing the method shown in the flowchart. In such an embodiment, the computer program can be downloaded and installed from the network through the communication device 909, or installed from the storage device 908 or from the ROM 902. When executed by the processing device 901, the computer program carries out the above-mentioned functions defined in the image processing method of the embodiment of the present disclosure.

It should be noted that the above-mentioned computer-readable medium in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or any combination of the above. More specific examples of computer-readable storage media may include, but not limited to, an electrical connection with one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium can be any tangible medium that contains or stores a program that can be used by or in combination with an instruction execution system, apparatus, or device. In this disclosure, the computer-readable signal medium may include a data signal propagated in baseband or as a part of a carrier wave, in which computer-readable program codes are carried. This propagated data signals can take many forms, including, but not limited to, electromagnetic signals, optical signals, or any suitable combination of the above. The computer-readable signal medium can also be any computer-readable medium other than the computer-readable storage medium, which can send, propagate, or transmit the program for use by or in connection with the instruction execution system, apparatus, or device. The program code contained in the computer-readable medium can be transmitted by any suitable medium, including but not limited to electric wire, optical cable, RF (radio frequency), etc., or any suitable combination of the above.

In some embodiments, the client and the server can communicate by using any currently known or future developed network protocol such as HTTP (HyperText Transfer Protocol), and can be interconnected with any form or medium of digital data communication (e.g., communication network). Examples of communication networks include a local area network (“LAN”), a wide area network (“WAN”), an internet network (e.g., the Internet) and end-to-end network (e.g., ad hoc end-to-end network), as well as any currently known or future developed networks.

The above-mentioned computer-readable medium may be included in the electronic device; or it can exist alone without being loaded into the electronic device.

The above-mentioned computer-readable medium carries one or more programs, which, when executed by the electronic device, cause the electronic device to execute the following: receiving a trigger operation acting on a preset control, wherein the preset control is displayed in a playing interface of a target video, and the playing interface is used for playing a target picture at an initial position; in response to the trigger operation, acquiring a target area associated with the preset control; and displaying a fusion interface of the target area and the target picture of the target video, wherein the target area appears from a preset position in the display interface and moves in a preset direction, and the target picture of the target video moves on the display interface from the initial position in the preset direction, and the target picture is kept in a playing state.

Alternatively, when the above programs are executed by the electronic device, the electronic device can further execute other steps described in the above described embodiments.

Computer program codes for performing the operations of the present disclosure can be written in one or more programming languages or a combination thereof, including object-oriented programming languages such as Java, Smalltalk, and C++, as well as conventional procedural programming languages such as “C” language or similar programming languages. The program codes can be completely executed on the user's computer, partially executed on the user's computer, executed as an independent software package, partially executed on the user's computer, and partially executed on the remote computer, or completely executed on the remote computer or server. In a case related to remote computers, the remote computers can be connected to the user computers through any kind of networks, including Local Area Network (LAN) or Wide Area Network (WAN), or can be connected to external computers (for example, through the Internet with Internet service providers).

The flowcharts and block diagrams in the drawings illustrate the architecture, functions, and operations of possible embodiments of systems, methods, and computer program products according to various embodiments of the present disclosure. In this regard, each block in the flowchart or block diagram may represent a module, a program segment, or a part of the code, which contains one or more executable instructions for implementing specified logical functions. It should also be noted that in some alternative implementations, the functions labeled in the blocks may also occur in a different order than those labeled in the drawings. For example, two blocks shown in succession can actually be executed substantially in parallel, and sometimes they can be executed in the reverse order, depending on the functions involved. It should also be noted that each block in the block diagram and/or flowchart, and the combination of blocks in the block diagram and/or flowchart, can be realized by a dedicated hardware-based system that performs specified functions or operations, or can be realized by a combination of dedicated hardware and computer instructions.

The units involved in the embodiments according to the present disclosure can be realized by software or hardware. Among them, the name of a unit does not constitute the limitation for the unit itself in some cases.

The functions described above herein can be at least partially performed by one or more hardware logic components. For example, without limitation, exemplary types of hardware logic components that can be used may include field programmable gate array (FPGA), application specific integrated circuit (ASIC), application specific standard product (ASSP), system on chip (SOC), complex programmable logic device (CPLD) and so on.

In the context of the present disclosure, a machine-readable medium can be a tangible medium that can contain or store a program for use by or in connection with an instruction execution system, apparatus, or device. The machine-readable medium can be a machine-readable signal medium or a machine-readable storage medium. The machine-readable medium may include, but not limited to, electronic, magnetic, optical, electromagnetic, infrared, or semiconductor systems, devices or equipment, or any suitable combination of the foregoing. More specific examples of machine-readable storage medium may include electrical connections based on one or more wires, portable computer disks, hard disks, random access memories (RAM), read-only memories (ROM), erasable programmable read-only memories (EPROM or flash memories), optical fibers, compact disk read-only memories (CD-ROMs), optical storage devices, magnetic storage devices, or any suitable combination of the above.

According to one or more embodiments of the present disclosure, the present disclosure provides a interface display method, including: receiving a trigger operation acting on a preset control, wherein the preset control is displayed in a playing interface of a target video, and the playing interface is used for playing a target picture at an initial position; in response to the trigger operation, acquiring a target area associated with the preset control; and displaying a fusion interface of the target area and the target picture of the target video, wherein the target area appears from a preset position in the display interface and moves in a preset direction, and the target picture of the target video moves on the display interface from the initial position in the preset direction, while the target picture is kept in a playing state.

According to one or more embodiments of the present disclosure, in the interface display method provided in the present disclosure, alternatively, in the fusion interface, the target area and the target picture of the target video are connected through a gradient layer.

According to one or more embodiments of the present disclosure, in the interface display method provided in the present disclosure, alternatively, the method also includes: in response to an operation of sliding a preset area in the fusion interface along a first direction, controlling the target area to move on the display interface along the first direction, so that a first area where the target area is displayed increases, and concurrently controlling the target picture of the target video to move on the display interface along the first direction, so that a second area where the target picture is displayed decreases.

According to one or more embodiments of the present disclosure, in the interface display method provided in the present disclosure, alternatively, the speed at which the target picture moves on the display interface along the first direction is smaller than the speed at which the target area moves on the display interface along the first direction.

According to one or more embodiments of the present disclosure, in the interface display method provided in the present disclosure, alternatively, in response to an operation of sliding a preset area in the fusion interface along a second direction, controlling the target area to move on the display interface along the second direction, so that a first area where the target area is displayed decreases, and concurrently controlling the target picture of the target video to move on the display interface along the second direction, so that a second area where the target picture is displayed increases.

According to one or more embodiments of the present disclosure, in the interface display method provided in the present disclosure, alternatively, when the target picture moves to the first set position on the display interface, the target picture is switched to a preset picture associated with the target area.

According to one or more embodiments of the present disclosure, in the interface display method provided in the present disclosure, alternatively, when the target picture moves to a second set position on the display interface, the target picture of the target video is hidden, and the target area is displayed in full screen.

According to one or more embodiments of the present disclosure, in the interface display method provided in the present disclosure, alternatively, after the target area is displayed in full screen, the method further includes: in response to an operation of sliding the target area along the second direction, controlling the target area to move on the display interface along the second direction, and concurrently controlling the playing interface for the target video to be restored and displayed on the display interface.

According to one or more embodiments of the present disclosure, in the interface display method provided in the present disclosure, alternatively, the method further includes: in response to a trigger operation acting on the first control in the fusion interface, controlling to close the target area and display the target picture of the target video in full screen.

According to one or more embodiments of the present disclosure, in the interface display method provided in the present disclosure, alternatively, when the target area and the target picture of the target video are concurrently displayed on the display interface, the first control is displayed in the target picture of the target video, and the target picture is also displayed with at least one preset control associated with the target area.

According to one or more embodiments of the present disclosure, in the interface display method provided in the present disclosure, alternatively, the target picture of the target video is a picture in which the size of the center area of the target picture matches the size of the second area displaying the target picture; or, the target picture of the target video is a picture for an target object in the target video that matches the second area in terms of size.

According to one or more embodiments of the present disclosure, in the interface display method provided in the present disclosure, alternatively, the method further includes: in response to a trigger operation acting on the sharing control, generating an information interface based on the target area for sharing; wherein, when the target area and the target picture are concurrently displayed on the display interface, the sharing control is displayed in the target picture.

According to one or more embodiments of the present disclosure, the present disclosure provides a interface display apparatus, including: a receiving module configured to receive a trigger operation acting on a preset control, wherein the preset control is displayed in a playing interface of a target video, and the playing interface is used for playing a target picture at an initial position; an acquisition module configured to, in response to the trigger operation, acquire a target area associated with the preset control; and a displaying module configured to display a fusion interface of the target area and the target picture of the target video, wherein the target area appears from a preset position in the display interface and moves in a preset direction, and the target picture of the target video moves on the display interface from the initial position in the preset direction, while the target picture is kept in a playing state.

According to one or more embodiments of the present disclosure, the present disclosure provides an electronic device, including:
one or more processors; and
a memory for storing one or more programs;
wherein the one or more programs, when executable by the one or more processors, cause the one or more processors to implement the interface display method provided by any embodiment of the present disclosure.

According to one or more embodiments of the present disclosure, the present disclosure provides a computer-readable storage medium storing a computer program which, when executed by a computer, implements the interface display method provided by any embodiment of the present disclosure.

The present disclosure also provides a computer program product, which includes computer programs or instructions, that, when executed by a processor, cause implementation of the interface display method provided by any embodiment of the present disclosure.

The above description is only the preferred embodiment of the present disclosure and the explanation of the applied technical principles. Those skilled in the art should understand that the disclosure scope involved in this disclosure is not limited to the technical solution formed by the specific combination of the above technical features, but also covers other technical solutions formed by any combination of the above technical features or their equivalent features without departing from the above disclosed concept, for example, a technical solution formed by exchanging the above features with the technical features with similar functions disclosed in this disclosure, without limitation.

Furthermore, although the operations are depicted in a particular order, this should not be understood as requiring these operations to be performed in the particular order shown or in sequential order. Under certain circumstances, multitasking and parallel processing may be beneficial. Similarly, although the above discussion contains a number of specific implementation details, these should not be interpreted as limitations on the scope of the present disclosure. Some features described in the context of separate embodiments can also be implemented in a single embodiment in combination. On the contrary, various features described in the context of a single embodiment can also be implemented in multiple embodiments individually or in any suitable sub-combination.

Although the subject matter has been described in language specific to structural features and/or logical acts of methods, it should be understood that the subject matter defined in the appended claims is not necessarily limited to the specific features or acts described above. On the contrary, the specific features and actions described above are only exemplary forms of implementing the claims.

1. A interface display method, comprising:
receiving a trigger operation acting on a preset control, wherein the preset control is displayed in a playing interface of a target video, and the playing interface is used for playing a target picture at an initial position;
in response to the trigger operation, acquiring a target area associated with the preset control; and
displaying a fusion interface of the target area and the target picture of the target video, wherein the target area appears from a preset position in the display interface and moves in a preset direction, and the target picture of the target video moves on the display interface from the initial position in the preset direction, while the target picture is kept in a playing state.

2. The method of claim 1, wherein, in the fusion interface, the target area and the target picture of the target video are connected through a gradient layer.

3. The method of claim 1, further comprising:
in response to an operation of sliding a preset area in the fusion interface along a first direction, controlling the target area to move on the display interface along the first direction, so that a first area where the target area is displayed increases, and concurrently controlling the target picture of the target video to move on the display interface along the first direction, so that a second area where the target picture is displayed decreases.

4. The method of claim 3, wherein, the speed at which the target picture moves on the display interface along the first direction is smaller than the speed at which the target area moves on the display interface along the first direction.

5. The method of claim 1, wherein, in response to an operation of sliding a preset area in the fusion interface along a second direction, the target area is controlled to move on the display interface along the second direction, so that a first area where the target area is displayed decreases, and the target picture of the target video is concurrently controlled to move on the display interface along the second direction, so that a second area where the target picture is displayed increases.

6. The method of claim 1, wherein, when the target picture moves to the first set position on the display interface, the target picture is switched to a preset picture associated with the target area.

7. The method of claim 1, wherein, when the target picture moves to a second set position on the display interface, the target picture of the target video is hidden, and the target area is displayed in full screen.

8. The method of claim 7, wherein, after the target area is displayed in full screen, the method further comprises:
in response to an operation of sliding the target area along the second direction, controlling the target area to move on the display interface along the second direction, and concurrently controlling the playing interface for the target video to be restored and displayed on the display interface.

9. The method of claim 1, wherein, the method further comprises:
in response to a trigger operation acting on the first control in the fusion interface, controlling to close the target area and display the target picture of the target video in full screen.

10. The method of claim 9, wherein, when the target area and the target picture of the target video are concurrently displayed on the display interface, the first control is displayed in the target picture of the target video, and the target picture is also displayed with at least one preset control associated with the target area.

11. The method of claim 1, wherein, the target picture of the target video is a picture in which the size of the center area of the target picture matches the size of the second area displaying the target picture; or,
the target picture of the target video is a picture for a target object in the target video that matches the second area in terms of size.

12. The method of claim 1, wherein, the method further comprises:
in response to a trigger operation acting on the sharing control, generating an information page based on the target area for sharing.

13. (canceled)

14. An electronic device, comprising:
one or more processors; and
a memory for storing one or more programs;
wherein the one or more programs, when executable by the one or more processors, cause the one or more processors to implement:
receiving a trigger operation acting on a preset control, wherein the preset control is displayed in a playing interface of a target video, and the playing interface is used for playing a target picture at an initial position;
in response to the trigger operation, acquiring a target area associated with the preset control; and
displaying a fusion interface of the target area and the target picture of the target video, wherein the target area appears from a preset position in the display interface and moves in a preset direction, and the target picture of the target video moves on the display interface from the initial position in the preset direction, while the target picture is kept in a playing state.

15. A non-transitory computer-readable storage medium storing a computer program which, when executed by a processor, implements:
receiving a trigger operation acting on a preset control, wherein the preset control is displayed in a playing interface of a target video, and the playing interface is used for playing a target picture at an initial position;
in response to the trigger operation, acquiring a target area associated with the preset control; and
displaying a fusion interface of the target area and the target picture of the target video, wherein the target area appears from a preset position in the display interface and moves in a preset direction, and the target picture of the target video moves on the display interface from the initial position in the preset direction, while the target picture is kept in a playing state.

16. (canceled)

17. The electronic device of claim 14, wherein, the one or more programs, when executable by the one or more processors, cause the one or more processors to further implement:
in response to an operation of sliding a preset area in the fusion interface along a first direction, controlling the target area to move on the display interface along the first direction, so that a first area where the target area is displayed increases, and concurrently controlling the target picture of the target video to move on the display interface along the first direction, so that a second area where the target picture is displayed decreases, and/or
in response to an operation of sliding a preset area in the fusion interface along a second direction, controlling the target area to move on the display interface along the second direction, so that a first area where the target area is displayed decreases, and concurrently controlling the target picture of the target video to move on the display interface along the second direction, so that a second area where the target picture is displayed increases.

18. The electronic device of claim 14, wherein, when the target picture moves to the first set position on the display interface, the target picture is switched to a preset picture associated with the target area, and/or
wherein, when the target picture moves to a second set position on the display interface, the target picture of the target video is hidden, and the target area is displayed in full screen.

19. The electronic device of claim 14, wherein, the one or more programs, when executable by the one or more processors, cause the one or more processors to further implement:
in response to a trigger operation acting on the first control in the fusion interface, controlling to close the target area and display the target picture of the target video in full screen, and/or
in response to a trigger operation acting on the sharing control, generating an information interface based on the target area for sharing.

20. The non-transitory computer-readable storage medium of claim 15, wherein, the computer program which, when executed by a processor, further implements:
in response to an operation of sliding a preset area in the fusion interface along a first direction, controlling the target area to move on the display interface along the first direction, so that a first area where the target area is displayed increases, and concurrently controlling the target picture of the target video to move on the display interface along the first direction, so that a second area where the target picture is displayed decreases, and/or
in response to an operation of sliding a preset area in the fusion interface along a second direction, controlling the target area to move on the display interface along the second direction, so that a first area where the target area is displayed decreases, and concurrently controlling the target picture of the target video to move on the display interface along the second direction, so that a second area where the target picture is displayed increases.

21. The non-transitory computer-readable storage medium of claim 15, wherein, when the target picture moves to the first set position on the display interface, the target picture is switched to a preset picture associated with the target area, and/or
wherein, when the target picture moves to a second set position on the display interface, the target picture of the target video is hidden, and the target area is displayed in full screen.

22. The non-transitory computer-readable storage medium of claim 15, wherein, the computer program which, when executed by a processor, further implements:
in response to a trigger operation acting on the first control in the fusion interface, controlling to close the target area and display the target picture of the target video in full screen, and/or
in response to a trigger operation acting on the sharing control, generating an information interface based on the target area for sharing.
